(19) United States
(12) Patent Application Publication
(10) Pub. No.: US 2026/0145819 A1
(43) Pub. Date: May 28, 2026

(54) METHOD FOR TRACKLET ASSOCIATION AND ORBIT PARAMETER ESTIMATION OF SPACE OBJECT

(71) Applicant: Beijing Institute of Technology, Beijing (CN)

(72) Inventors: Han CAI, Beijing (CN); Yihang JIANG, Beijing (CN); Jingrui ZHANG, Beijing (CN); Keying YANG, Beijing (CN)

(21) Appl. No.: 19/399,976

(22) Filed: Nov. 25, 2025

(30) Foreign Application Priority Data
Nov. 26, 2024 (CN) 202411702753.7
Jan. 20, 2025 (CN) 202510083237.9

(51) Int. Cl. B64G 3/00; B64G 1/24; G06F 17/11

(52) U.S. Cl. CPC B64G 3/00; B64G 1/242; B64G 1/244; G06F 17/11

(57) ABSTRACT

Method for tracklet association and orbit parameter estimation of space object includes: propagating orbit to observation epoch, calculating average NIS of the tracklet, and determining whether the tracklet is abnormal according to the average NIS. If the tracklet is normal, the tracklet is directly associated with an object in cataloging database, no maneuver occurs, filtering method is used to update tracklet, and the cataloging database is updated. If the tracklet is abnormal, maneuver association and maneuver parameter joint estimation are triggered. Joint estimation method takes maneuver time and maneuver vector as optimized variables, calculates the average NIS, solves optimization problem by minimizing the average NIS to obtain optimal loss function and optimal maneuver parameters, sets a loss function threshold and maneuver parameter range to determine association, performs iteration for maneuver association until all tracklets are processed, and then obtains tracklet association and maneuver parameters.

### CROSS-REFERENCE TO RELATED APPLICATIONS

This patent application claims the benefits and priorities of Chinese Patent Application No. 202510083237.9 filed with the CNIPA on Jan. 20, 2025, and Chinese Patent Application No. 202411702753.7 filed with the CNIPA on Nov. 26, 2024, the both disclosures of which are incorporated by reference herein in their entireties as part of the application.

### TECHNICAL FIELD

The present disclosure relates to a method for tracklet association and orbit parameter estimation of a space object, and belongs to the field of space situational awareness.

### BACKGROUND

With the increase of the number of objects in Earth orbit, near-Earth space has become more crowded, and the collision risk between spacecraft increases significantly. This risk is further heightened by the orbital maneuvers of certain spacecraft, which may pose an additional threat to others. In view of the importance of Geosynchronous Orbit (GEO) spacecraft, the safety of GEO region has become a major focus of attention. Since the GEO spacecraft is far away from the Earth, ground-based and space-based optical sensors are typically used to monitor the GEO region. However, due to the high relative velocity, large number of targets, and limited number of sensors, the resulting observation arcs are often short, leading to the frequent generation of tracklets with sparse and limited observational data during monitoring missions. It is very challenging to use a single tracklet for orbit determination and catalog maintenance. Such tracklets that cannot be associated with any cataloged object are usually referred to as an Uncorrelated Tracklet (UCT). In order to solve this problem, a lot of research is devoted to tracklet association, so that more accurate orbit determination and cataloging can be performed by using a plurality of associated tracklets. A major challenge in this process is that the spacecraft frequently maneuvers in order to maintain its orbital position or perform other tasks. The maneuvered tracklet may be mistaken for another object, and mistakenly introduced into the cataloging database. Tracklet association of object maneuver is considered to be more challenging, because limited information usually needs to be used to estimate maneuver parameters to determine whether the maneuver parameters are associated.

In order to cope with this challenge, many studies have applied an optimal control strategy to perform maneuver association, that is, evaluate the association between the tracklets obtained before and after maneuver. The loss function obtained by the optimal control strategy can be used as an indicator to determine the association. In addition, this method can also use orbit information to characterize maneuver. An orbit-to-orbit maneuver association method based on an optimal control theory was proposed by Serra et al., and this method is extended to orbit-to-track maneuver association by using range and range rate Constrained Admissible Region (CAR).

The accuracy of association can be improved by estimating maneuver parameters, i.e., maneuver time and the change of velocity vectors, and using these estimated parameters to refine association. Some scholars have put forward specific methods for maneuver parameter estimation. For instance, an optimization framework was established by Siminski et al. to solve the most probable orbit state after maneuver, in which the range and the range rate of the tracklet are taken as optimized variables. This method depends on prior information, and is suitable for the situation where the orbit state before maneuver is known and enough historical maneuver data is available. A maneuver estimation strategy using a least square method was proposed by Pastor et al., assuming that the initial orbit and the maneuver direction of the object are known. This method uses a plurality of tracklet data after maneuver to estimate the maneuver time and the change of velocity. These methods can solve the challenge of maneuver parameter estimation to some extent. However, the methods cannot be directly applied to maneuver association, and usually depend on the results of maneuver association. Without accurate association results, the accuracy of parameter estimation may decrease, making it impossible to correctly estimate the orbit state of the object after maneuver for threat assessment, which may even leads to potential collision.

To sum up, in order to accurately determine the association of maneuver tracklets, it is necessary to estimate maneuver parameters. Meanwhile, in order to estimate the maneuver parameters accurately, it is very important to solve the maneuver association. In the previous research methods, both maneuver association and maneuver parameter estimation require a large amount of prior information. Therefore, it is very challenging to jointly evaluate the association and estimate the maneuver parameters by using optical tracklet observation data in the case of limited prior information. In addition, prior studies have demonstrated that formulating the association and maneuver parameter estimation problem as an optimization problem has a significant prospect. In particular, optimization-based method exhibits extremely high efficiency when solving the challenge of large-scale tracklet association. Therefore, on the basis of limited prior information, the present disclosure jointly completes tracklet association and maneuver parameter estimation by building a well-founded optimization framework.

### SUMMARY

In order to solve the problem of coupling between maneuver parameter estimation and tracklet association, an object of the present disclosure is to provide a method for tracklet association and orbit parameter estimation of a space object, which further obtains a Normalized Innovation Square (NIS) and an average NIS by calculating the innovation and the covariance between the tracklet observation value and the predicted value, so as to detect the abnormality of the tracklet. For the abnormal tracklet originating from the pulse maneuver of the object, the optimal parameters of maneuver time and maneuver vectors are estimated based on the constructed maneuver parameter estimation optimization problem to improve the accuracy of tracklet association and orbit parameter estimation of the space object.

The objective of the present disclosure is achieved by the following technical solution.

The present disclosure provides a method for tracklet association and orbit parameter estimation of a space object. A space object orbit cataloging database is given, including orbital states and covariances of all objects before maneuver. After a tracklet observation value is obtained, the orbit of the corresponding object is propagated to the observation epoch of the tracklet, and an average NIS is calculated to determine whether the tracklet is abnormal according to the average NIS. That is, the tracklet may be generated after maneuver or originate from other objects. If the tracklet is not abnormal, it can be directly associated with an object in the catalog without any indication of maneuver occurs, a filtering method is used to update the tracklet, and the cataloging database is updated. Conversely, if the tracklet is determined as abnormal, maneuver association and maneuver parameter joint estimation are triggered. In the joint estimation method, maneuver time Δt and a maneuver vector Δv are set as optimized variables, where Δv=[Δv_{R}, Δv_{S}, Δv_{W}]^{T}. The orbit data in the cataloging database is propagated to the maneuver time Δt. The pulse maneuver Δv is applied. Then, the maneuvered orbit is propagated to the observation epoch. The average NIS of the tracklet is calculated. The optimization problem is solved by minimizing the average NIS of the tracklet, which serves as the objective function to obtain an optimal loss value and the corresponding optimal maneuver parameters. A threshold of the loss function and ranges of the maneuver parameters are set to determine the association. The minimum loss function is compared with the set maneuver association threshold. If the optimal loss function is higher than the threshold, it can be determined that the tracklet is a tracklet associated after maneuver, the solved maneuver parameters are accepted, and the tracklet is reserved. Iterative processing continues in combination with the observation value of the next tracklet. On the contrary, it can be determined that the tracklet originates from other objects, and is not associated. The solved maneuver parameters are rejected, and the tracklet is skipped. Iteration is performed for determining the maneuver association until all tracklets have been processed, and then the tracklet association and the maneuver parameters are obtained to achieve the tracklet association and the orbit parameter estimation of the space object.

The present disclosure discloses a method for tracklet association and orbit parameter estimation of a space object, including the following steps:
step 1, determining whether a tracklet is abnormal based on an average NIS including:
using an orbit propagator to propagate orbit data to an observation epoch, calculating an average NIS of a tracklet observation value and a predicted observation value of orbital propagation, and determining that the tracklet is abnormal when the average NIS is higher than or equal to a set abnormality threshold [symbol] , which indicates that the tracklet is observed after a pulse maneuver, or is a tracklet originating from other objects;
step 2, constructing an optimization problem of maneuver parameter estimation including:
setting maneuver time Δt and a maneuver vector Δv as optimized variables, wherein Δv=[Δv_{R}, Δv_{S}, Δv_{W}]^{T}, propagating an orbit to the maneuver time Δt, applying the pulse maneuver Δv, then propagating the maneuvered orbit to the observation epoch, calculating the average NIS of the tracklet as an optimization object function, and using a maneuver parameter as an optimized variable to achieve construction of the optimization problem of maneuver parameter estimation;
step 3, based on an optimized solution result, estimating an orbit parameter, and determining whether there is maneuver association including:
using an optimization method to solve the optimization problem in step 2 to obtain an optimal maneuver parameter between the tracklet and an object and a corresponding optimal loss function fₘᵢₙ; when the optimal loss function value fₘᵢₙ is less than a preset evaluation optimization threshold [symbol] , determining that the tracklet is in maneuver association with the object, that is, the tracklet is observed after the object has been maneuvered, and is associated with the object; when fₘᵢₙ≥ [symbol] , determining that the tracklet is not associated with the object, and the tracklet observation value originates from the other objects and is not associated with the object; and
step 4, iterating step 1 to step 3 for determining the maneuver association until all tracklets are processed to obtain the tracklet association and the maneuver parameter, and then, determining the orbit by using a filtering method to achieve the orbit parameter estimation.

Further, the specific implementation of Step 1 is as follows:
the orbit data in a cataloging database is propagated to the observation epoch, and the average NIS is calculated:
innovation \tilde{y}ₖ is calculated:

$${\tilde{y}}_{k} = {y}_{k} - {\hat{y}}_{k} \qquad ( 1 )$$

where the subscript k represents a k-th step; yₖ represents the tracklet observation value; ŷₖ represents the predicted observation value, and an unscented transformation is used to obtain:

$${\hat{y}}_{k} = {\sum }_{i = 0}^{2 n} {w}_{i}^{( m )} h ( {\hat{x}}_{k}^{( i )} ) \qquad ( 2 )$$

where n represents a dimension of the orbit state;

$${w}_{i}^{( m )}$$

represents an average weight in the unscented transformation with a sum of 1; h(⋅) represents an observation function;

$${\hat{x}}_{k}^{( i )}$$

represents a predicted orbit state; and a covariance Sₖ of the innovation \tilde{y}ₖ is calculated by a sigma point in the unscented transformation:

$${S}_{k} = {\sum }_{i = 0}^{2 n} {w}_{i}^{( c )} ( h ( {\hat{x}}_{k}^{( i )} ) - {\hat{y}}_{k} ) {( h ( {\hat{x}}_{k}^{( i )} ) - {\hat{y}}_{k} )}^{T} + {R}_{k} \qquad ( 3 )$$

where

$${w}_{i}^{( c )}$$

represents a covariance weight in the unscented transformation; and Rₖ represents an observation covariance;
based on the innovation \tilde{y}ₖ and the covariance Sₖ, a normalized innovation ηₖ is calculated by the following formula:

$${η}_{k} = {S}_{k}^{- \frac{1}{2}} {\tilde{y}}_{k} \qquad ( 4 )$$

a normalized innovation square

$${η}_{k}^{2}$$

is

$${η}_{k}^{2} = {η}_{k}^{T} {η}_{k} = {\tilde{y}}_{k}^{T} {S}_{k}^{- 1} {\tilde{y}}_{k} \qquad ( 5 )$$

where the normalized innovation ηₖ is a Gaussian quantity with a zero mean and a unit covariance, and

$${η}_{k}^{2}$$

follows a distribution of

$${χ}_{N}^{2} ,$$

where N is a measured dimension; and the average NIS value η̅² in any time window is:

$${\overline{η}}^{2} = \frac{1}{{N}_{0}} {\sum }_{k = 1}^{{N}_{0}} {η}_{k}^{2} \qquad ( 6 )$$

where N₀ is the number of observations of the tracklet;
when η̅² exceeds a user-defined threshold [symbol] , an expected measurement value is inconsistent with an actual measurement value, which indicates that there is an abnormality; and the abnormality indicates that the tracklet is observed after the pulse maneuver, or is the tracklet originating from the other objects.

Further, the specific implementation of Step 2 is as follows:
the maneuver time Δt and the maneuver vector Δv are set as optimized variables, wherein Δv=[Δv_{R}, Δv_{S}, Δv_{W}]^{T}, a cataloging orbit under an Earth-Centered Inertial (ECI) system is propagated to the maneuver time Δt to obtain an orbit X⁻=[r⁻, v⁻] under the ECI system during Δt⁻ before the maneuver time, the pulse maneuver Δv is applied after the orbit X⁻ is transferred to a Radial, Along-track, and Cross-track (RSW) orbital coordinate system, and then the transferred orbit is transferred to the ECI system to obtain an orbit X⁺=[r⁺, v⁺] under the ECI system during Δt⁺ after the maneuver time, wherein an orbit position does not change instantaneously due to the pulse maneuver, r⁺=r⁻; then, the orbit is propagated to the observation epoch of the tracklet, the average NIS η̅² of the tracklet is calculated by using Formula (1) to Formula (6), and the average NIS is used as a loss function f(Δt, Δv) of the optimization problem:

$$f ( Δ t , Δ v ) = \frac{1}{{N}_{0}} {\sum }_{k = 1}^{{N}_{0}} {η}_{k}^{2} ( Δ t , Δ v ) \qquad ( 7 )$$

for the maneuver time Δt, the maneuver occurs within the following boundary:

$${t}_{0} < Δ t < {t}_{e n d} \qquad ( 8 )$$

where t₀ represents a last epoch observed before the maneuver, that is, a last cataloging time in the cataloging database; and t_{end} represents a first epoch observed after the maneuver;
a range of the maneuver vector is:

$${0 \leq ‖ Δ v ‖ \leq ‖Δ v ‖}_{max} \qquad ( 9 )$$

where ∥⋅∥ represents a two-norm for calculating modulus of an vector; ∥Δv∥ₘₐₓ represents a maximum value of the pulse maneuver vector; and
to sum up, the optimization problem of the maneuver parameter estimation is:

$$min f ( Δ t , Δ v ) = \frac{1}{{N}_{0}} {\sum }_{k = 1}^{{N}_{0}} {η}_{k}^{2} ( Δ t , Δ v ) \qquad ( 10 )$$

$$s . t . {t}_{0} < Δ t < {t}_{e n d}$$

$${0 \leq ‖ Δ v ‖ \leq ‖Δ v ‖}_{max}$$

Further, based on an orbit parameter estimated in step 4, a dynamic parameter during maneuver is corrected, and an orbit state after maneuver is estimated by using the filtering method to improve orbit accuracy.

Further, the method further includes the following steps: based on the orbit parameter estimated in step 4, performing iterative processing on all possible tracklets in maneuver association to improve accuracy of the maneuver parameter estimation.

### Beneficial Effects:

1. The method for tracklet association and orbit parameter joint estimation of the space object provided by the present disclosure involves propagating the orbit to the observation epoch, calculating an average NIS of the tracklet, determining whether the tracklet is abnormal according to the NIS, and determining whether the tracklet needs to be subjected to maneuver association and joint estimation according to the abnormality. By optimizing the maneuver time and the maneuver vector, the optimal maneuver parameters are obtained with the minimized average NIS of the tracklet as an optimization object, so that the accuracy of tracklet association is further improved. This method can accurately determine whether the tracklet is abnormal, identify the maneuver tracklet in time, and reasonably estimate the maneuver parameters in a complex space environment, thus effectively improving the accuracy of tracklet association, reducing the false association or missing association caused by object maneuver, and improving the reliability of the overall space object tracking system.

2. The method for tracklet association and orbit parameter joint estimation of the space object provided by the present disclosure uses the observation information to calculate the association possibility by inverting the possible maneuver of the object, and performs tracklet association and maneuver parameter estimation in combination with a small amount of optical observation data without relying on a large amount of prior information. By reducing the dependence on prior information, the data acquisition process is simplified, and the data complexity and data acquisition difficulty in the practical application are reduced, so that this method is more applicable and flexible in the practical application. In particular, in the case of limited or incomplete data acquisition, high accuracy and stability can be kept.

3. The method for tracklet association and orbit parameter joint estimation of the space object provided by the present disclosure determines and optimizes tracklet association by reasonably setting the threshold of the loss function and the range of the maneuver parameters. This method can still maintain high robustness and reliability in the complex space environment and the changing object behaviors, effectively deal with complex situations, avoid wrong association determination, improve the stability of a tracklet association system, and ensure that the object tracklet association and the maneuver parameter estimation can be completed efficiently and accurately in the dynamic and complex environment.

4. The method for tracklet association and orbit parameter joint estimation of the space object provided by the present disclosure accurately estimates the maneuver parameters by using an optimization method. This method can accurately correct the orbit parameters during maneuver, improve the orbit determination accuracy, and then achieve more accurate object orbit prediction and tracking. At the same time, this method can monitor the maneuverability of non-cooperative objects, provide in-depth analysis and prediction of non-cooperative object behaviors, and improve the all-round performance of the space object identification and tracking system.

### BRIEF DESCRIPTION OF THE DRAWINGS

FIG. 1 is a flowchart of a method for tracklet association and orbit parameter joint estimation of a space object.

FIGS. 2A-2B are schematic diagrams of abnormality detection based on a NIS.

FIG. 3 is a schematic diagram of maneuver association determination of an optimal loss function.

### DETAILED DESCRIPTION OF THE EMBODIMENTS

The present disclosure will be further explained with reference to the accompanying drawings and embodiments.

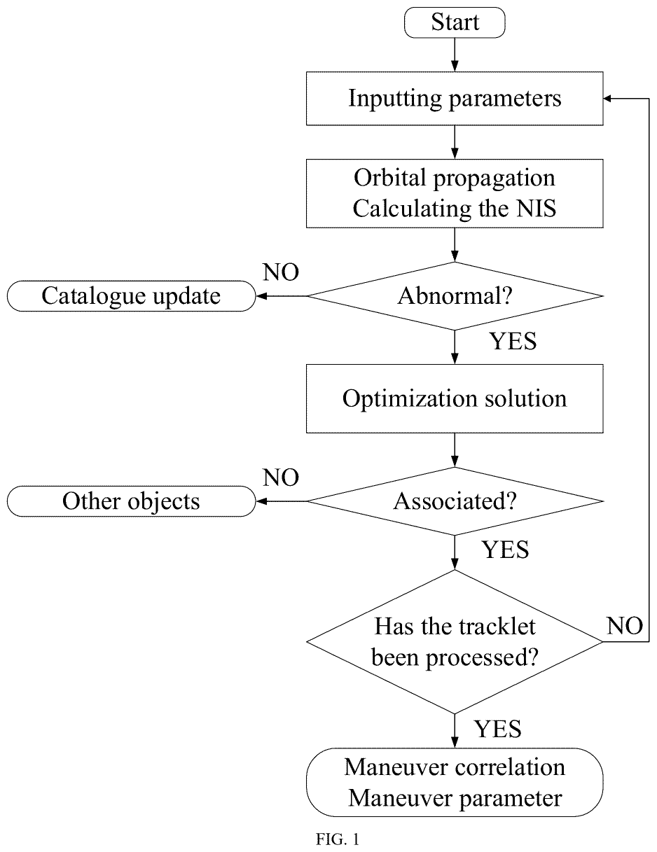

As shown in FIG. 1, the method for tracklet association and orbit parameter joint estimation of the space object according to this embodiment has the following specific steps.

An orbit propagator is used together with unscented transformation to propagate orbit data to an observation epoch to obtain a predicted orbit state \hat{x}ₖ of a sigma point at step k, and the predicted observation value ŷₖ and covariance Sₖ at each observation time point are calculated:

$${\hat{y}}_{k} = {\sum }_{i = 0}^{2 n} {w}_{i}^{( m )} h ( {\hat{x}}_{k}^{( i )} ) \qquad ( 11 )$$

$${S}_{k} = {\sum }_{i = 0}^{2 n} {w}_{i}^{( c )} ( h ( {\hat{x}}_{k}^{( i )} ) - {\hat{y}}_{k} ) {( h ( {\hat{x}}_{k}^{( i )} ) - {\hat{y}}_{k} )}^{T} + {R}_{k} \qquad ( 12 )$$

Then, the normalized innovation ηₖ and square

$${η}_{k}^{2}$$

are calculated:

$${η}_{k} = {S}_{k}^{- \frac{1}{2}} {\tilde{y}}_{k} \qquad ( 13 )$$

$${η}_{k}^{2} = {η}_{k}^{T} {η}_{k} = {\tilde{y}}_{k}^{T} {S}_{k}^{- 1} {\tilde{y}}_{k} \qquad ( 14 )$$

After obtaining all NISs in the tracklet, the average NIS η̅² of the tracklet is calculated:

$${\overline{η}}^{2} = \frac{1}{{N}_{0}} {\sum }_{k = 1}^{{N}_{0}} {η}_{k}^{2} \qquad ( 15 )$$

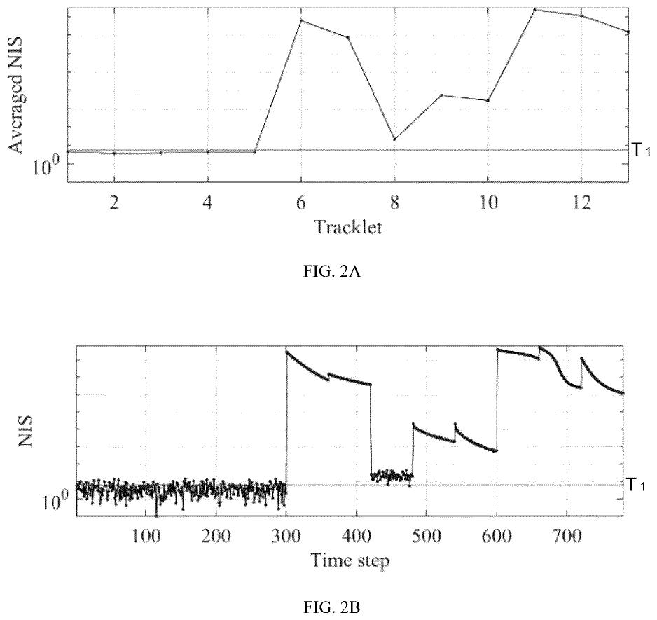

The average NIS η̅² is compared with a threshold [symbol] . If η̅² is less than [symbol] , it is considered that the tracklet is directly associated with a cataloging object, and the tracklet can be used to update the orbit state of the cataloging object. If η̅² is greater than [symbol] , it is considered that the tracklet is abnormal for a secondary object, this tracklet may originate from other objects or indicate that the object has been maneuvered, and thus further determination for the tracklet is required. The determination of the NIS and the threshold [symbol] is shown in FIGS. 2A-2B. FIG. 2B shows the NIS at each time point, and FIG. 2A shows the average NIS of each tracklet, i.e., η̅². A horizontal line, as shown in FIGS. 2A-2B, is the threshold [symbol] . It can be seen that η̅² of the first five tracklets is below the threshold, indicating that the first five tracklets are directly associated tracklets, η̅² of the last eight tracklets is above the threshold, and then further determination is required.

First, a framework of the optimization problem is built. Maneuver time Δt and a maneuver vector Δv are set as optimized variables, where Δv=[Δv_{R}, Δv_{S}, Δv_{W}]^{T}. A cataloging orbit under an Earth-Centered Inertial (ECI) system is propagated to the maneuver time Δt to obtain the orbit X⁻=[r⁻, v⁻] under the ECI system during Δt⁻ before the maneuver time. The pulse maneuver Δv is applied after X⁻ is transferred to a Radial, Along-track, and Cross-track (RSW) orbital coordinate system, where a transformation matrix

$${C}_{ECI}^{R S W}$$

from the ECI coordinate system to the RSW coordinate system is:

$${C}_{ECI}^{RSW} = {[ \frac{{r}^{-}}{‖ {r}^{-} ‖} \frac{{r}^{-} \times {v}^{-}}{‖ {r}^{-} \times {v}^{-} ‖} \times \frac{{r}^{-}}{‖ {r}^{-} ‖} \frac{{r}^{-} \times {v}^{-}}{‖ {r}^{-} \times {v}^{-} ‖} ]}^{T} \qquad ( 16 )$$

Then, the transferred orbit is transferred to the ECI system to obtain the orbit X⁺=[r⁺, v⁺] under the ECI system during Δt⁺ after the maneuver time, where the orbit position does not change instantaneously due to the pulse maneuver, i.e., r⁺=r⁻;

$${v}^{+} = {C}_{R S W}^{ECI} ( {C}_{E C 1}^{R S W} {v}^{-} + Δ v ) ,$$

where

$${C}_{R S W}^{ECI}$$

is a transformation matrix from the RSW coordinate system to the ECI coordinate system,

$${C}_{R S W}^{ECI} = {( {C}_{ECI}^{R S W} )}^{T} .$$

Then, the orbit is propagated to the observation epoch of the tracklet. The average NIS η̅² of the tracklet is calculated, and the average NIS is used as a loss function f(Δt, Δv) of the optimization problem. Moreover, constraint ranges of the maneuver time and the maneuver vector are set to establish the optimization problem:

$$min f ( Δ t , Δ v ) = \frac{1}{{N}_{0}} {\sum }_{k = 1}^{{N}_{0}} {η}_{k}^{2} ( Δ t , Δ v ) \qquad ( 17 )$$

$$s . t . {t}_{0} < Δ t < {t}_{e n d}$$

$${0 \leq ‖ Δ v ‖ \leq ‖Δ v ‖}_{max} .$$

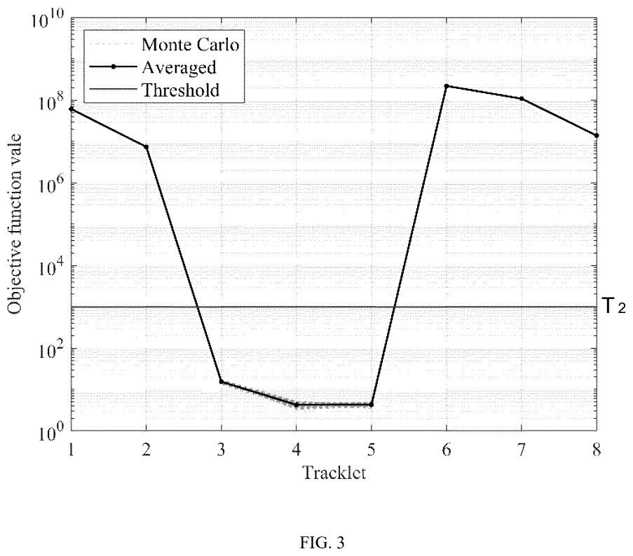

The optimization algorithm is used to solve the optimization problem to obtain the optimal loss function fₘᵢₙ and the optimal maneuver parameters: Δtₒₚₜ and Δvₒₚₜ. If the optimal loss function value fₘᵢₙ is less than another user-defined evaluation optimization threshold [symbol] , and the maneuver parameters are within the specified constraint range, it can be determined that the tracklet is in maneuver association with the object, that is, the tracklet is observed and associated with the object after the object has been maneuvered, and the solved optimal maneuver parameters are also accepted at the same time. In addition, the tracklet observation value can be used through a filtering method to improve the accuracy of the orbit. On the contrary, if fₘᵢₙ> [symbol] , it is considered that the tracklet is not associated with the object. Iterative processing is performed on all possible tracklets in maneuver association to improve accuracy of maneuver parameter estimation. The comparison between the optimal loss function fₘᵢₙ and the threshold [symbol] is shown in FIG. 3. FIG. 3 shows the results of Monte Carlo operations for 50 times, in which the dotted line is the optimal loss function of each Monte Carlo operation, the node line is the average value of the 50 Monte Carlo operations, and the horizontal line is the threshold [symbol] . It can be seen that fₘᵢₙ< [symbol] at the 3nd-5th tracklets, which indicates that these tracklets are in maneuver association, and the other five tracklets originate from other objects. An average estimation error of the maneuver time is 44.97 s, and an average estimation error of the maneuver amplitude is 0.0046 m/s.

The above detailed description further explains the object, the technical solution and the beneficial effects of the present disclosure. It should be understood that the above description is only a specific embodiment of the present disclosure, and is not used to limit the protection scope of the present disclosure. Any modification, equivalent substitution, and improvement made within the spirit and principle of the present disclosure should be included in the protection scope of the present disclosure.

What is claimed is:

1. A method for tracklet association and orbit parameter estimation of a space object, comprising:
step 1, determining whether a tracklet is abnormal based on an average Normalized Innovation Square (NIS) comprising:
using an orbit propagator to propagate orbit data to an observation epoch, calculating an average NIS of a tracklet observation value and a predicted observation value of orbital propagation, and determining that the tracklet is abnormal when the average NIS is higher than or equal to a set abnormality threshold [symbol] , which indicates that the tracklet is observed after a pulse maneuver, or is a tracklet originating from other objects;
step 2, constructing an optimization problem of maneuver parameter estimation comprising:
setting maneuver time Δt and a maneuver vector Δv as optimized variables, wherein Δv=[Δv_{R}, Δv_{S}, Δv_{W}]^{T}, propagating an orbit to the maneuver time Δt, applying the pulse maneuver Δv, then propagating the maneuvered orbit to the observation epoch, calculating the average NIS of the tracklet as an optimization object function, and using a maneuver parameter as an optimized variable to achieve construction of the optimization problem of maneuver parameter estimation;
step 3, based on an optimized solution result, estimating an orbit parameter, and determining whether there is maneuver association comprising:
using an optimization method to solve the optimization problem in step 2 to obtain an optimal maneuver parameter between the tracklet and an object and a corresponding optimal loss function fₘᵢₙ; when the optimal loss function value fₘᵢₙ is less than a preset evaluation optimization threshold [symbol] , determining that the tracklet is in maneuver association with the object, that is, the tracklet is observed after the object has been maneuvered, and is associated with the object; when fₘᵢₙ≥ [symbol] , determining that the tracklet is not associated with the object, and the tracklet observation value originates from the other objects and is not associated with the object; and
step 4, iterating step 1 to step 3 for determining the maneuver association until all tracklets are processed to obtain the tracklet association and the maneuver parameter, and then, determining the orbit by using a filtering method to achieve the orbit parameter estimation.

2. The method for tracklet association and orbit parameter estimation of the space object according to claim 1, further comprising: based on an orbit parameter estimated in step 4, correcting a dynamic parameter during maneuver, and estimating an orbit state after maneuver by using the filtering method to improve orbit accuracy.

3. The method for tracklet association and orbit parameter estimation of the space object according to claim 1, further comprising: based on an orbit parameter estimated in step 4, performing iterative processing on all possible tracklets in maneuver association to improve accuracy of the maneuver parameter estimation.

4. The method for tracklet association and orbit parameter estimation of the space object according to claim 1, wherein a specific implementation of step 1 is as follows:
the orbit data in a cataloging database is propagated to the observation epoch, and the average NIS is calculated:
innovation \tilde{y}ₖ is calculated:
$${\tilde{y}}_{k} = {y}_{k} - {\hat{y}}_{k} \qquad ( 1 )$$
wherein k represents a k-th step; yₖ represents the tracklet observation value; ŷₖ represents the predicted observation value, and an unscented transformation is used to obtain:
$${\hat{y}}_{k} = {\sum }_{i = 0}^{2 n} {w}_{i}^{( m )} h ( {\hat{x}}_{k}^{( i )} ) \qquad ( 2 )$$
wherein n represents a dimension of the orbit state;
$${w}_{i}^{( m )}$$
represents an average weight in the unscented transformation with a sum of 1; h(⋅) represents an observation function;
$${\hat{x}}_{k}^{( i )}$$
represents a predicted orbit state; and a covariance Sₖ of the innovation ŷₖ is calculated by a sigma point in the unscented transformation:
$${S}_{k} = {\sum }_{i = 0}^{2 n} {W}_{i}^{( c )} ( h ( {\hat{x}}_{k}^{( i )} ) - {\hat{y}}_{k} ) {( h ( {\hat{x}}_{k}^{( i )} ) - {\hat{y}}_{k} )}^{T} + {R}_{k} \qquad ( 3 )$$
wherein
$${w}_{i}^{( c )}$$
represents a covariance weight in the unscented transformation; and Rₖ represents an observation covariance;
based on the innovation ŷₖ and the covariance Sₖ, a normalized innovation ηₖ is calculated by the following formula:
$${η}_{k} = {S}_{k}^{- \frac{1}{2}} {\tilde{y}}_{k} \qquad ( 4 )$$
a normalized innovation square
$${η}_{k}^{2}$$
is
$${η}_{k}^{2} = {η}_{k}^{T} {η}_{k} = {\tilde{y}}_{k}^{T} {S}_{k}^{- 1} {\tilde{y}}_{k} \qquad ( 5 )$$
wherein the normalized innovation ηₖ is a Gaussian quantity with a zero mean and a unit covariance, and
$${η}_{k}^{2}$$
follows a distribution of
$${χ}_{N}^{2} ,$$
wherein N is a measured dimension; and the average NIS value η̅² in any time window is:
$${\overline{η}}^{2} = \frac{1}{{N}_{0}} {\sum }_{k = 1}^{{N}_{0}} {η}_{k}^{2} \qquad ( 6 )$$
wherein No is a number of observations of the tracklet;
when η̅² exceeds a user-defined threshold [symbol] , an expected measurement value is inconsistent with an actual measurement value, which indicates that there is an abnormality; and
the abnormality indicates that the tracklet is observed after the pulse maneuver, or is the tracklet originating from the other objects.

5. The method for tracklet association and orbit parameter estimation of the space object according to claim 4, wherein a specific implementation of step 2 is as follows:
the maneuver time Δt and the maneuver vector Δv are set as optimized variables, wherein Δv=[Δv_{R}, Δv_{S}, Δv_{W}]^{T}, a cataloging orbit under an Earth-Centered Inertial (ECI) system is propagated to the maneuver time Δt to obtain an orbit X⁻=[r⁻, v⁻] under the ECI system during Δt⁻ before the maneuver time, the pulse maneuver Δv is applied after the orbit X⁻ is transferred to a Radial, Along-track, and Cross-track (RSW) orbital coordinate system, and then the transferred orbit is transferred to the ECI system to obtain an orbit X⁺=[r⁺, v⁺] under the ECI system during Δt⁺ after the maneuver time, wherein an orbit position does not change instantaneously due to the pulse maneuver, r⁺=r⁻; then, the orbit is propagated to the observation epoch of the tracklet, the average NIS η² of the tracklet is calculated by using Formula (1) to Formula (6), and the average NIS is used as a loss function f(Δt, Δv) of the optimization problem:
$$f ( Δ t , Δ v ) = \frac{1}{{N}_{0}} {\sum }_{k = 1}^{{N}_{0}} {η}_{k}^{2} ( Δ t , Δ v ) \qquad ( 7 )$$
for the maneuver time Δt, the maneuver occurs within the following boundary:
$${t}_{0} < Δ t < {t}_{e n d} \qquad ( 8 )$$
wherein t₀ represents a last epoch observed before the maneuver, that is, a last cataloging time in the cataloging database; and t_{end} represents a first epoch observed after the maneuver;
a range of the maneuver vector is:
$$0 \leq ‖ Δ v ‖ \leq {‖ Δ v ‖}_{max} \qquad ( 9 )$$
wherein ∥⋅∥ represents a two-norm for calculating modulus of an vector; ∥Δv∥ₘₐₓ represents a maximum value of the pulse maneuver vector; and to sum up, the optimization problem of the maneuver parameter estimation is:
$$min f ( Δ t , Δ v ) = \frac{1}{{N}_{0}} {\sum }_{k = 1}^{{N}_{0}} {η}_{k}^{2} ( Δ t , Δv ) \qquad ( 10 )$$
$$s . t . {t}_{0} < Δ t < {t}_{e n d}$$
$$0 \leq ‖ Δ v ‖ \leq {‖ Δ v ‖}_{max} .$$

6. The method for tracklet association and orbit parameter estimation of the space object according to claim 2, wherein a specific implementation of step 1 is as follows:
the orbit data in a cataloging database is propagated to the observation epoch, and the average NIS is calculated:
innovation \tilde{y}ₖ is calculated:
$${\tilde{y}}_{k} = {y}_{k} - {\hat{y}}_{k} \qquad ( 1 )$$
wherein k represents a k-th step; yₖ represents the tracklet observation value; ŷₖ represents the predicted observation value, and an unscented transformation is used to obtain:
$${\hat{y}}_{k} = {\sum }_{i = 0}^{2 n} {w}_{i}^{( m )} h ( {\hat{x}}_{k}^{( i )} ) \qquad ( 2 )$$
wherein n represents a dimension of the orbit state;
$${w}_{i}^{( m )}$$
represents an average weight in the unscented transformation with a sum of 1; h(⋅) represents an observation function;
$${\hat{x}}_{k}^{( i )}$$
represents a predicted orbit state; and a covariance Sₖ of the innovation \tilde{y}ₖ is calculated by a sigma point in the unscented transformation:
$${S}_{k} = {\sum }_{i = 0}^{2 n} {w}_{i}^{( c )} ( h ( {\hat{x}}_{k}^{( i )} ) - {\hat{y}}_{k} ) {( h ( {\hat{x}}_{k}^{( i )} ) - {\hat{y}}_{k} )}^{T} + {R}_{k} \qquad ( 3 )$$
wherein
$${w}_{i}^{( c )}$$
represents a covariance weight in the unscented transformation; and Rₖ represents an observation covariance;
based on the innovation \tilde{y}ₖ and the covariance Sₖ, a normalized innovation ηₖ is calculated by the following formula:
$${η}_{k} = {S}_{k}^{- \frac{1}{2}} {\tilde{y}}_{k} \qquad ( 4 )$$
a normalized innovation square
$${η}_{k}^{2}$$
is
$${η}_{k}^{2} = {η}_{k}^{T} {η}_{k} = {\tilde{y}}_{k}^{T} {S}_{k}^{- 1} {\tilde{y}}_{k} \qquad ( 5 )$$
wherein the normalized innovation ηₖ is a Gaussian quantity with a zero mean and a unit covariance, and
$${η}_{k}^{2}$$
follows a distribution of
$${χ}_{N}^{2} ,$$
wherein N is a measured dimension; and the average NIS value η̅² in any time window is:
$${\overline{η}}^{2} = \frac{1}{{N}_{0}} {\sum }_{k = 1}^{{N}_{0}} {η}_{k}^{2} \qquad ( 6 )$$
wherein N₀ is a number of observations of the tracklet;
when η̅² exceeds a user-defined threshold [symbol] , an expected measurement value is inconsistent with an actual measurement value, which indicates that there is an abnormality; and
the abnormality indicates that the tracklet is observed after the pulse maneuver, or is the tracklet originating from the other objects.

7. The method for tracklet association and orbit parameter estimation of the space object according to claim 6, wherein a specific implementation of step 2 is as follows:
the maneuver time Δt and the maneuver vector Δv are set as optimized variables, wherein Δv=[Δv_{R}, Δv_{S}, Δv_{W}]^{T}, a cataloging orbit under an Earth-Centered Inertial (ECI) system is propagated to the maneuver time Δt to obtain an orbit X⁻=[r⁻, v⁻] under the ECI system during Δt⁻ before the maneuver time, the pulse maneuver Δv is applied after the orbit X⁻ is transferred to a Radial, Along-track, and Cross-track (RSW) orbital coordinate system, and then the transferred orbit is transferred to the ECI system to obtain an orbit X⁺=[r⁺, v⁺] under the ECI system during Δt⁺ after the maneuver time, wherein an orbit position does not change instantaneously due to the pulse maneuver, r⁺=r⁻; then, the orbit is propagated to the observation epoch of the tracklet, the average NIS η̅² of the tracklet is calculated by using Formula (1) to Formula (6), and the average NIS is used as a loss function f(Δt, Δv) of the optimization problem:
$$f ( Δ t , Δ v ) = \frac{1}{{N}_{0}} {\sum }_{k = 1}^{{N}_{0}} {η}_{k}^{2} ( Δ t , Δ v ) \qquad ( 7 )$$
for the maneuver time Δt, the maneuver occurs within the following boundary:
$${t}_{0} < Δ t < {t}_{end} \qquad ( 8 )$$
wherein t₀ represents a last epoch observed before the maneuver, that is, a last cataloging time in the cataloging database; and t_{end} represents a first epoch observed after the maneuver;
a range of the maneuver vector is:
$$0 \leq ‖ Δ v ‖ \leq {‖ Δ v ‖}_{max} \qquad ( 9 )$$
wherein |⋅∥ represents a two-norm for calculating modulus of an vector; ∥Δv∥ₘₐₓ represents a maximum value of the pulse maneuver vector; and to sum up, the optimization problem of the maneuver parameter estimation is:
$$min f ( Δ t , Δ v ) = \frac{1}{{N}_{0}} {\sum }_{k = 1}^{{N}_{0}} {η}_{k}^{2} ( Δ t , Δ v ) \qquad ( 10 )$$
$$s . t . {t}_{0} < Δ t < {t}_{end}$$
$$0 \leq ‖ Δ v ‖ \leq {‖ Δ v ‖}_{max}$$

8. The method for tracklet association and orbit parameter estimation of the space object according to claim 3, wherein a specific implementation of step 1 is as follows:
the orbit data in a cataloging database is propagated to the observation epoch, and the average NIS is calculated:
innovation \tilde{y}ₖ is calculated:
$${\tilde{y}}_{k} = {y}_{k} - {\hat{y}}_{k} \qquad ( 1 )$$
wherein k represents a k-th step; yₖ represents the tracklet observation value; ŷₖ represents the predicted observation value, and an unscented transformation is used to obtain:
$${\hat{y}}_{k} = {\sum }_{i = 0}^{2 n} {w}_{i}^{( m )} h ( {\hat{x}}_{k}^{( i )} ) \qquad ( 2 )$$
wherein n represents a dimension of the orbit state;
$${w}_{i}^{( m )}$$
represents all average weight in the unscented transformation with a sum of 1; h(⋅) represents an observation function;
$${\hat{x}}_{k}^{( i )}$$
represents a predicted orbit state; and a covariance Sₖ of the innovation \tilde{y}ₖ is calculated by a sigma point in the unscented transformation:
$${S}_{k} = {\sum }_{i = 0}^{2 n} {w}_{i}^{( c )} ( h ( {\hat{x}}_{k}^{( i )} ) - {\hat{y}}_{k} ) {( h ( {\hat{x}}_{k}^{( i )} ) - {\hat{y}}_{k} )}^{T} + {R}_{k} \qquad ( 3 )$$
wherein
$${w}_{i}^{( c )}$$
represents a covariance weight in the unscented transformation; and Rₖ represents an observation covariance;
based on the innovation \tilde{y}ₖ and the covariance Sₖ, a normalized innovation ηₖ is calculated by the following formula:
$${η}_{k} = {S}_{k}^{- \frac{1}{2}} {\tilde{y}}_{k} \qquad ( 4 )$$
a normalized innovation square
$${η}_{k}^{2}$$
is:
$${η}_{k}^{2} = {η}_{k}^{T} {η}_{k} = {\tilde{y}}_{k}^{T} {S}_{k}^{- 1} {\tilde{y}}_{k} \qquad ( 5 )$$
wherein the normalized innovation ηₖ is a Gaussian quantity with a zero mean and a unit covariance, and
$${η}_{k}^{2}$$
follows a distribution of
$${χ}_{N}^{2} ,$$
wherein N is a measured dimension; and the average NIS value η̅² in any time window is:
$${\overline{η}}^{2} = \frac{1}{{N}_{0}} {\sum }_{k = 1}^{{N}_{0}} {η}_{k}^{2} \qquad ( 6 )$$
wherein N₀ is a number of observations of the tracklet;
when η̅² exceeds a user-defined threshold [symbol] , an expected measurement value is inconsistent with an actual measurement value, which indicates that there is an abnormality; and the abnormality indicates that the tracklet is observed after the pulse maneuver, or is the tracklet originating from the other objects.

9. The method for tracklet association and orbit parameter estimation of the space object according to claim 8, wherein a specific implementation of step 2 is as follows:
the maneuver time Δt and the maneuver vector Δv are set as optimized variables, wherein Δv=[Δv_{R}, Δv_{S}, Δv_{W}]^{T}, a cataloging orbit under an Earth-Centered Inertial (ECI) system is propagated to the maneuver time Δt to obtain an orbit X⁻=[r⁻, v⁻] under the ECI system during Δt⁻ before the maneuver time, the pulse maneuver Δv is applied after the orbit X⁻ is transferred to a Radial, Along-track, and Cross-track (RSW) orbital coordinate system, and then the transferred orbit is transferred to the ECI system to obtain an orbit X⁺=[r⁺, v⁺] under the ECI system during Δt⁺ after the maneuver time, wherein an orbit position does not change instantaneously due to the pulse maneuver, r⁺=r⁻; then, the orbit is propagated to the observation epoch of the tracklet, the average NIS η̅² of the tracklet is calculated by using Formula (1) to Formula (6), and the average NIS is used as a loss function f(Δt, Δv) of the optimization problem:
$$f ( Δ t , Δ v ) = \frac{1}{{N}_{0}} {\sum }_{k = 1}^{{N}_{0}} {η}_{k}^{2} ( Δ t , Δ v ) \qquad ( 7 )$$
for the maneuver time Δt, the maneuver occurs within the following boundary:
$${t}_{0} < Δ t < {t}_{end} \qquad ( 8 )$$
wherein t₀ represents a last epoch observed before the maneuver, that is, a last cataloging time in the cataloging database; and t_{end} represents a first epoch observed after the maneuver;
a range of the maneuver vector is:
$$0 \leq ‖ Δν ‖ \leq {‖ Δν ‖}_{max} \qquad ( 9 )$$
wherein ∥⋅∥ represents a two-norm for calculating modulus of an vector; ∥Δv∥ₘₐₓ represents a maximum value of the pulse maneuver vector; and to sum up, the optimization problem of the maneuver parameter estimation is:
$$\begin{matrix}min f ( Δ t , Δ v ) = \frac{1}{{N}_{0}} {\sum }_{k = 1}^{{N}_{0}} {η}_{k}^{2} ( Δ t , Δ ν ) \\ s . t . {t}_{0} < Δ t < {t}_{end} \\ 0 \leq ‖ Δν ‖ \leq {‖ Δν ‖}_{max}\end{matrix} . \qquad ( 10 )$$
